(19) United States
(12) Patent Application Publication
(10) Pub. No.: US 2004/0029457 A1
(43) Pub. Date: Feb. 12, 2004

(54) Contact element for an electrical plug connection

(76) Inventor: Martin Jourdan, Marbach (DE)

Correspondence Address: KENYON & KENYON, ONE BROADWAY, NEW YORK, NY, 10004, US

(21) Appl. No.: 10/398,351

(22) PCT Filed: Jun. 26, 2002
(86) PCT No.: PCT/DE02/02325

(30) Foreign Application Priority Data
Aug. 7, 2001 (DE) 101 38 755.5

(51) Int. Cl. H01R 9/22

(52) U.S. Cl. 439/894

(57) ABSTRACT

A contact element (11) for an electrical plug connection is to be designed in such a way that it remains functionally stable even under unfavorable operating conditions. The contact element (11) has a contact inner part (12) which is regionally covered by a contact outer part (13). The contact inner part (12) includes a center section, which is able to rebound axially, on which cutouts (24) having a precise axial first dimension (26) are formed. Able to be inserted into the cutouts (24) are molded members (27), which have a precise second dimension (29), of the contact outer part (13) so as to form stops (32) which limit the axial mobility of the center section (22) to 100-200 μm.

The contact element (11) is intended for use in the automotive industry.

### BACKGROUND INFORMATION

The present invention is directed to a contact element for an electrical plug connection of the type set forth in claim 1. Such a contact element is known from DE 90 17 536 U.

The contact element, here referred to as a plug and socket connector, has a receiving region for a pin-shaped or flat-bladed mating contact of a mating connector at a longitudinal end on the receiving side. At the other longitudinal end of the contact element is a mounting region. A center section situated between the two longitudinal ends has an elastically flexible design, especially in the longitudinal direction, so as to prevent relative movements between the receiving region of the contact element and the mating connector, these movements causing chafing corrosion in the contact areas.

The maximum deflection of this spring element in the longitudinal direction is limited only by the frictional grip between the contact points of the receiving region and the mating contact. If it is exceeded, the contact points slip on the mating contact and the spring element undergoes no further deflection.

Generally, the frictional grip and, thus, the maximally possible deflection of the spring element in the longitudinal direction, is so great under the operating conditions which exist during the operation of a motor vehicle that the fatigue-strength range of the spring element is exceeded.

As a result, in a high number of heavy load changes, contacts sockets having such a design are in danger of breaking, due to vibrations, which can lead to the loss of the electrical plug-in connection. This must be prevented.

### SUMMARY OF THE INVENTION

In contrast, the contact element for an electrical plug-in connection according to the present invention, having the characterizing features of claim 1, has the advantage over the related art that the aforementioned shortcomings are able to be avoided to a satisfactory extent.

To this goal, the contact element has at least one stop limiting the axial mobility of a center section of the contact element, inside of which the contacting by a mating contact of a mating connector takes place.

In this way, the axial mobility of the center contact may be restricted to such a degree that the contact element, even when exposed to high and frequent vibration stresses, remains below a Woehler curve, which delimits the fatigue-strength range as a function of the stress and the number of load changes. A functionally stable contact element for an electrical plug-in connection is thus produced.

Advantageous embodiments for implementing the present invention are specified in the dependent claims. In accordance with claim 3, the stop is formed by a molded member, able to be produced with precise dimensions, the member, according to claim 4, being bent about a bending axis that essentially extends in parallel to an insertion direction of the contact element. As a result, the narrowly toleranced dimensional standard is able to be implemented in the molded member and the positioning of the molded member in a recess of a center section, which is adapted in its measurement to the stop, will not influence the dimensional adjustment between the stop and the recess.

### BRIEF DESCRIPTION OF THE DRAWINGS

An exemplary embodiment of the present invention is shown in the drawing and explained in greater detail in the following description.

The figures show:

FIG. 1 the contact element in a perspective representation;

FIG. 2 a segment of the contact element with an inner contact part, also in a perspective representation; and

FIG. 3 a segment of the contact element, in a sectional view.

### DESCRIPTION OF THE EXEMPLARY EMBODIMENT

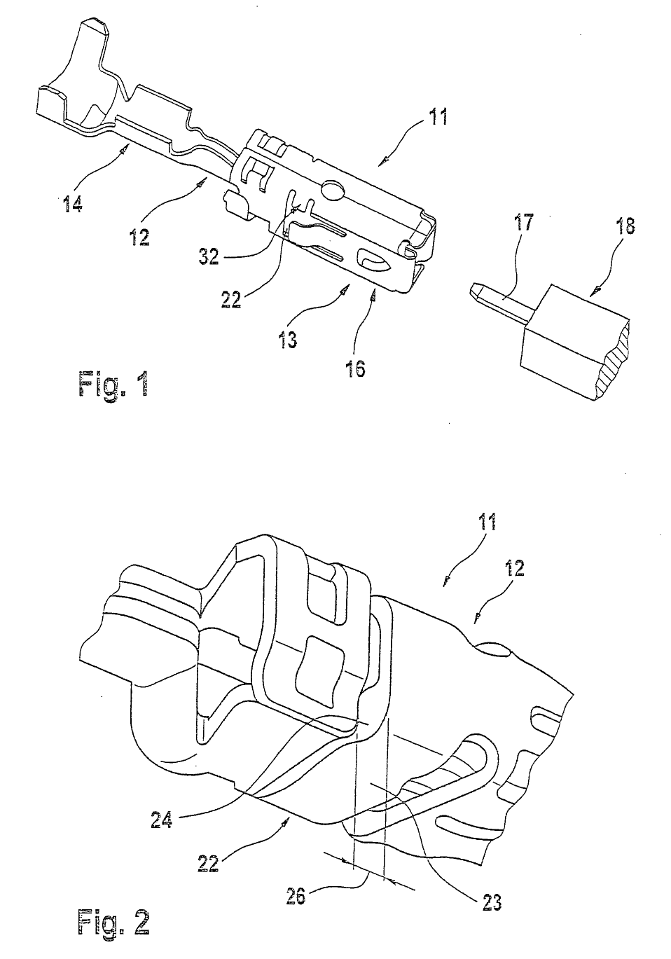

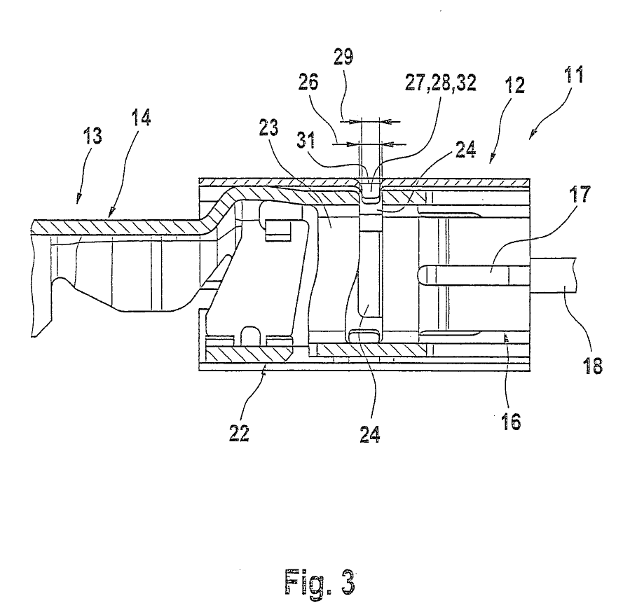

According to FIGS. 1 and 3, a contact element 11 for an electrical plug-in connection is made up of a contact inner part 12 and a contact outer part 13, the latter regionally overlapping contact inner part 12.

In its axial longitudinal extension, which also represents the insertion direction of contact element 11, contact inner part 12 has a connecting section 14 on one end and a contact section 16 on the other end.

Connecting section 14 is designed as a two-step crimp connection, for an electrical conductor on one side and an insulation of an electric cable (not shown further) on the other side. Contact section 16, intended to accommodate a mating contact 17 (represented only schematically) of a mating connector 18, is usually designed to include at least two contact springs (not shown further), which form a contact cone that is able to rebound. A contact point forms at each contact spring when a mating contact 17 is inserted.

Situated between connecting section 14 and contact section 16 is a center section 22 which is meander-shaped according to FIG. 2 and thus has an, especially, axial spring-action capability. Formed between adjacent individual sections 23 of center section 22 are cutouts 24, each of whose axial extensions has a narrowly toleranced first dimension 26.

Contact inner part 12, in the region of contact section 16 and center section 22, is largely enveloped by contact outer part 13, which is held in place at contact inner part 12 between connecting section 16 and center section 22 in a manner not shown further.

In this exemplary embodiment, four molded members 27, which are spaced at a distance from each other, are formed by way of example on box-shaped contact outer part 13. These molded members 27 are embodied by tabs 28, which are produced in a stamping process. Molded members 27 each have an axially extending second dimension 29 produced with a high degree of precision.

By a folding/bending procedure, molded members 27 in each case are folded over an axially extending cutting edge 31 at contact outer part 13, into associated recesses 24, where they form stops 32 for contact inner part 12.

Axially extending cutting edges 31 have the effect of subjecting folded-over stops 32 to pressure in parallel to cutting edge 31. In this way, stops 32 have high rigidity in the axially extending loading direction and do not give way when a center section 22 strikes against them.

Given a centered position of molded members 27 with respect to cutouts 24, one-sided axial deflections at center section 22 are limited to a maximum distance of 50-100 μm since first dimension 26 is larger than second dimension 29 by only 100-200 μm. As a result, the danger of fatigue fractures in center section 22 is eliminated, even given a very high number of load changes, as they may occur, for instance, by vibration stresses in an electrical plug connection that is attached to a motor vehicle engine during its operation. Thus, a contact element 11 is realized which functions in a reliable manner even when exposed to unfavorable dynamic loads.

What is claimed is:

1. A contact element for an electrical plug connection, comprising a contact inner part (12) which is at least partially covered by a contact outer part (13), this contact inner part (12), which is axially aligned with an insertion direction, having a connecting section (14) at one end and a contact section (16) for a mating contact (17) of a mating connector (18) at the other end, and additionally having a center section (22) which has an axially flexible design and is situated between the connecting section (14) and the contact section (16),
wherein the contact element (11) has at least one stop (32) which limits the axial mobility of the center section (22).

2. The contact element as recited in claim 1,
wherein the stop (32) is attached to the contact outer part (13) and projects into a cutout (24) of the center section (22).

3. The contact element as recited in claim 2,
wherein the stop (32) is formed by a molded member (27), which is able to be produced with dimensional precision from the center section (22), a second dimension (29) of the axial extension of the molded member being less than a first dimension (26) of the axial extension of the cutout (24).

4. The contact element as recited in claim 3,
wherein the molded member (27) is embodied by a stamped-out tab (28) that is folded over a cutting edge (31) which extends essentially in parallel to an axially oriented insertion direction.

5. The contact element as recited in claim 4,
wherein the first dimension (26) is 100-200 μm greater than the second dimension (29).

6. The contact element as recited in claim 5,
wherein the contact outer part (13) has four stops (32), which lie opposite from each other in pairs and engage with four associated cutouts (24) of the center section (22).
